(19) United States
(12) Patent Application Publication
(10) Pub. No.: US 2015/0244058 A1
(43) Pub. Date: Aug. 27, 2015

(54) Electronic Device Having Antenna Module

(71) Applicant: Smart Approach Co., Ltd., Zhudong Township (TW)

(72) Inventor: Lien Chih Lin, Zhudong Township (TW)

(21) Appl. No.: 14/708,337

(22) Filed: May 11, 2015

Related U.S. Application Data
(63) Continuation-in-part of application No. 13/019,347, filed on Feb. 2, 2011.

(30) Foreign Application Priority Data
Dec. 22, 2010 (TW) 099224827

(51) Int. Cl. H01Q 1/22; H01Q 9/42; H01Q 1/48

(52) U.S. Cl. CPC H01Q 1/2266; H01Q 1/48; H01Q 9/42

(57) ABSTRACT

The antenna module includes a transparent substrate and an antenna component disposed on the transparent substrate. The antenna component includes a radiation portion, a feed portion and a grounding portion. The grounding portion is located at a corner of the transparent substrate, and the grounding portion includes a first strip portion and a second strip portion that are connected and integrated.

### BACKGROUND OF THE INVENTION

1. Field of Invention

The present invention relates to an antenna module, and more particularly to an antenna module disposed on a transparent substrate.

2. Related Art

With the development of wireless communication technologies, a user may use a wireless communication system to transmit information without being limited by landforms, which results in an increase in number and type of electronic products using the wireless communication technologies, for example, portable electronic devices such as a notebook computer, a cell phone and a personal digital assistant (PDA), and thus an antenna for receiving and sending electromagnetic wave signals becomes one of the essential components in a wireless communication device.

Taking the notebook computer as an example, to meet the purchasing trend of the current consumers, the notebook computers in the market are all designed and developed to be lighter and thinner. Therefore, the size of the antenna for receiving and sending the radio electromagnetic wave signals should be smaller, or the structure and shape thereof should be changed, so that the antenna can be successfully disposed in a limited space inside the notebook computer.

A conventional antenna module may be an independent component additionally disposed inside the electronic device (portable electronic devices such as a notebook computer, a cell phone and a PDA). For example, the additional disposition of the antenna module inside the cell phone as an independent component may cause a larger volume of the cell phone. Therefore, the antenna module is directly installed on a mother board of the cell phone in the prior art, so as to reduce the volume occupied by the antenna module. However, the antenna module of such a design occupies a large area on the mother board, thus affecting the disposition of other electronic components (such as a capacitor, an inductor, a resistor, a diode and a transistor) on the mother board. In other words, since the development of the cell phone has a thinner and smaller trend, the space inside the cell phone is more crowded. Therefore, the manner of disposing the antenna module inside the cell phone in the prior art causes many difficulties when engineers design the space distribution of components inside the cell phone.

### SUMMARY OF THE INVENTION

Accordingly, the present invention is an antenna module and an electronic device having the same, so as to solve the problem in the prior art that the space layout and distribution of components inside the electronic device are difficult.

The present invention provides an antenna module, which comprises a transparent substrate and an antenna component, and the antenna component is disposed on the transparent substrate. The antenna component comprises at least one radiation portion, a feed portion and a grounding portion. The grounding portion is located at a corner of the transparent substrate, the grounding portion has a first strip portion and a second strip portion, and an end of the first strip portion is approximately perpendicularly connected to an end of the second strip portion.

The present invention provides an electronic device, which comprises a mother board, a display panel and an antenna module. The display panel is overlapped on and coupled to the mother board. The antenna module comprises a transparent substrate and an antenna component. The transparent substrate is overlapped and covers on the display panel, and the transparent substrate and the mother board are located on two opposite surfaces of the display panel. The antenna component is disposed on the corner of the transparent substrate, and the antenna component comprises at least one radiation portion, a feed portion and a grounding portion. The grounding portion is located at a corner of the transparent substrate, the grounding portion has a first strip portion and a second strip portion, and an end of the first strip portion is approximately perpendicularly connected to an end of the second strip portion.

The present invention provides a touch module, which comprises a touch screen and an antenna module. The antenna module comprises a transparent substrate and an antenna component. The transparent substrate is overlapped on the touch screen, and the transparent substrate and a mother board are located on two opposite surfaces of the display panel. The antenna component is disposed on the transparent substrate, and the antenna component comprises at least one radiation portion, a feed portion and a grounding portion. The grounding portion is located at a corner of the transparent substrate, the grounding portion has a first strip portion and a second strip portion, and an end of the first strip portion is approximately perpendicularly connected to an end of the second strip portion.

In the antenna module of the present invention, the shape of the grounding portion is improved to a shape appropriate to be placed at the corner of the transparent substrate, so that the antenna component can be directly formed and overlapped on the transparent substrate on the display panel.

In addition, since the antenna component is directly formed and overlapped on the transparent substrate on the display panel, the manufacturing process thereof is relatively simple, and the space of the electronic device occupied by the antenna module can be reduced. Furthermore, compared with the prior art in which the disposition of the antenna component on the mother board causes difficulty for the layout of other electronic components, the antenna module of the present invention can avoid the difficulty in the prior art. Therefore, such an antenna module has good structural integrity, and facilitates the smaller and thinner development trend of the electronic device.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a schematic structural view of an antenna module according to an embodiment of the present invention;

FIG. 2 is a schematic structural view of the antenna module according to another embodiment of the present invention;

FIG. 3 is a schematic three-dimensional view of an electronic device having an antenna module according to an embodiment of the present invention;

FIG. 4 is a schematic enlarged view of the antenna module in FIG. 3;

FIG. 5 is a schematic structural view of an electronic device according to another embodiment of the present invention; and

FIG. 6 is a schematic structural view of a touch screen according to another embodiment of the present invention.

### DETAILED DESCRIPTION OF THE INVENTION

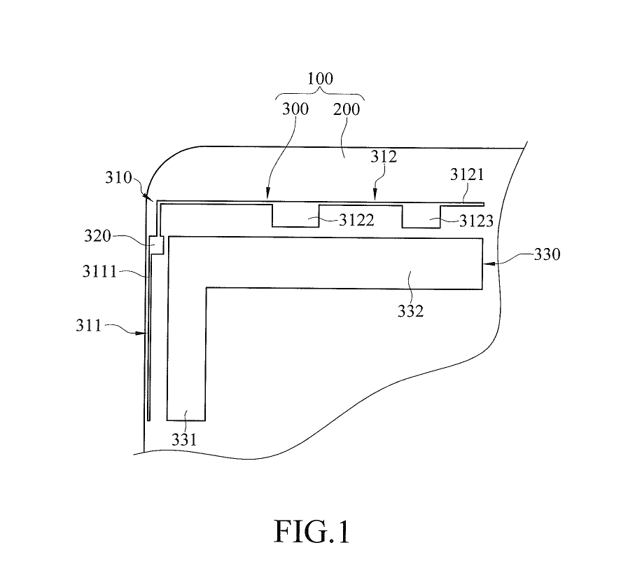

FIG. 1 is a schematic structural view of an antenna module 100 according to an embodiment of the present invention.

Referring to FIG. 1A, the antenna module 100 according to the embodiment of the present invention comprises a transparent substrate 200 and an antenna component 300. The transparent substrate 200 may be, but is not limited to, a glass substrate, an acryl substrate or a plastic substrate. The transparent substrate is rectangular, but is not limited thereto. The antenna component 300 is disposed on the corner of the transparent substrate 200, and the antenna component 300 comprises at least one radiation portion 310, a feed portion 320 and a grounding portion 330. Beside, the antenna component 300 is not disposed on mother board and the lateral surfaces of the transparent substrate 200.

The antenna component 300 is formed at a corner of the transparent substrate 200. In this embodiment, the antenna component 300 may be formed on the transparent substrate 200 through an electroplating manner, but is not limited thereto. For example, the antenna component 300 may be formed on the transparent substrate 200 by means of printing, sputtering, laser engraving, pressing or by other chemical or physical vapor deposition methods.

In this embodiment, the radiation portion 310 comprises a first radiation portion 311 and a second radiation portion 312. The end of the first radiation portion is directly connected to an end of the second radiation portion and the end of the first radiation portion is approximately perpendicular to the end of the second radiation portion. The first radiation portion is substantially parallel to the first strip portion, and the second radiation portion is substantially parallel to the second strip portion. The first radiation portion 311 has a first axle portion 3111, and the second radiation portion 312 has a second axle portion 3121, a first block 3122 and a second block 3123. The first block 3122 and the second block 3123 are electrically connected to the second axle portion 3121. An end of the first axle portion 3111 is electrically connected to an end of the second axle portion 3121, and the first axle portion 3111 is substantially perpendicular to the second axle portion 3121. The first block 3122 and the second block 3123 act as impedance matching.

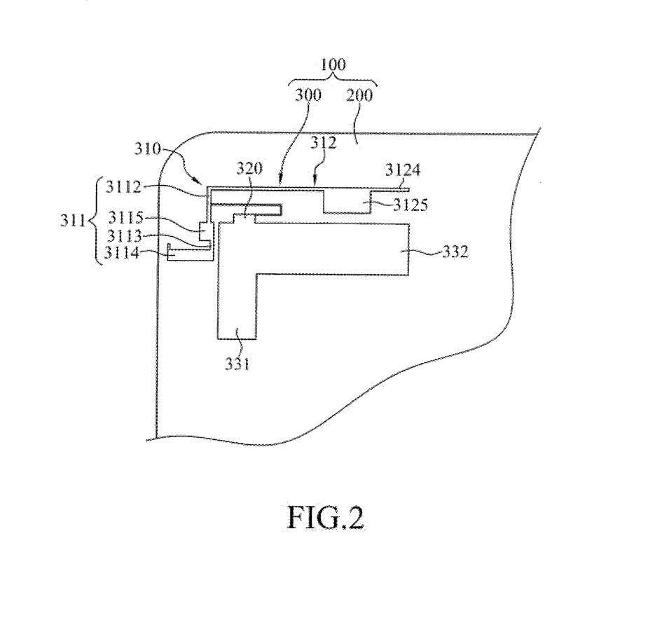

In addition, a frequency band range of the first radiation portion 311 is different from that of the second radiation portion 312, for example, the frequency band range of the first radiation portion 311 is 2.4 GHZ to 2.4835 GHZ, and the frequency band range of the second radiation portion 312 is 4.9 GHZ to 5.35 GHZ, which are not limited thereto. It should be noted that, the number of the radiation portion 310 is not intended to limit the present invention. For example, the number of the radiation portion 310 may be two as shown in FIG. 2, and may also be greater or smaller than 2. Therefore, the number of the radiation portion 310 may be adjusted according to actual requirements of a single frequency or multiple frequencies. In addition, the feed portion 320 is disposed in the radiation portion 310, and transmits external signals through a cable (not shown).

Moreover, the grounding portion 330 has a first strip portion 331 and a second strip portion 332. An end of the first strip portion 331 is approximately perpendicularly and electrically connected to an end of the second strip portion 332, so that a combination of the first strip portion 331 and the second strip portion 332 is generally in an L-shaped geometric form. In addition, the grounding portion 330 is located at a corner of the transparent substrate 200, and thus the first strip portion 331 and the second strip portion 332 are respectively located at two edges of the corner of the transparent substrate 200. On the other hand, the first axle portion 3111 is substantially parallel to the first strip portion 331□ the second axle portion 3121 is substantially parallel to the second strip portion 332. Therefore, the location of the antenna component 300 would not affect display area of the display panel 430 because the antenna component 300 is disposed on the corner of the transparent substrate 200. Moreover, in other embodiment, the antenna component 300 disposed on the corner of the transparent substrate 200 would be covered by the frame of the electronic device 400, so it also would not affect the user's view.

Another embodiment of the antenna module 100 according to the present invention will be introduced hereinafter. The manner of forming the antenna component 300 on the transparent substrate 200, the structure of the grounding portion 330 and the frequency band range of the radiation portion 310 are already illustrated in detail above, and will not be described herein again. Merely the structure of the radiation portion 310 will be illustrated below. FIG. 2 is a schematic structural view of the antenna module 100 according to another embodiment of the present invention. Referring to FIG. 2, in this embodiment, the radiation portion 310 comprises a first radiation portion 311 and a second radiation portion 312. The first radiation portion 311 comprises a first antenna shaft 3112, a second antenna shaft 3113, a first rectangular portion 3114 and a second rectangular portion 3115. The first rectangular portion 3114 and the second rectangular portion 3115 are electrically connected to the second antenna shaft 3113, and an end of the second antenna shaft 3113 is electrically connected to an end of the first antenna shaft 3112. The second radiation portion 312 has a third antenna shaft 3124 and a third block 3125, and the third block 3125 is electrically connected to the third antenna shaft 3124. The first rectangular portion 3114, the second rectangular portion 3115 and the third block 3124 act as impedance matching. The first antenna shaft 3112 and the second antenna shaft 3113 are substantially parallel to the first strip portion 331□ the third antenna shaft 3124 is substantially parallel to the second strip portion 332.

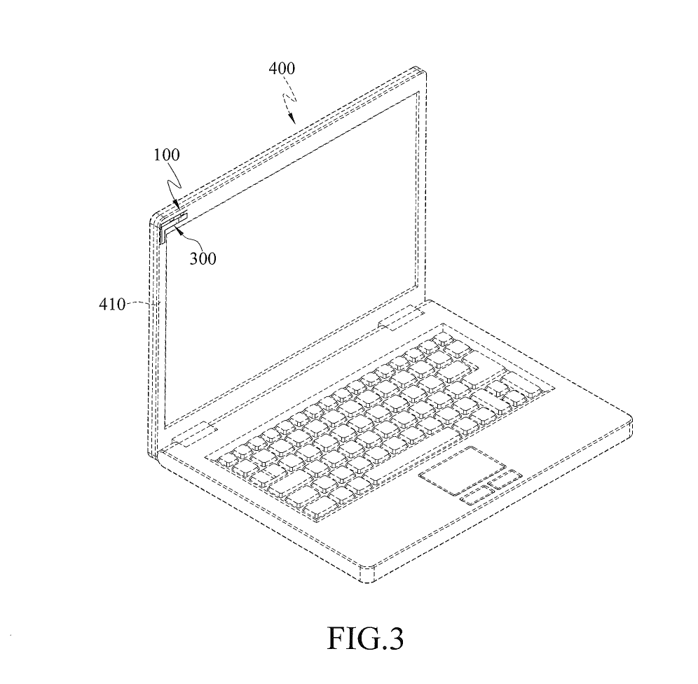

An electronic device 400 having the antenna module 100 of this embodiment will be illustrated below. FIG. 3 is a schematic three-dimensional view of the electronic device 400 having the antenna module 100 according to an embodiment of the present invention;

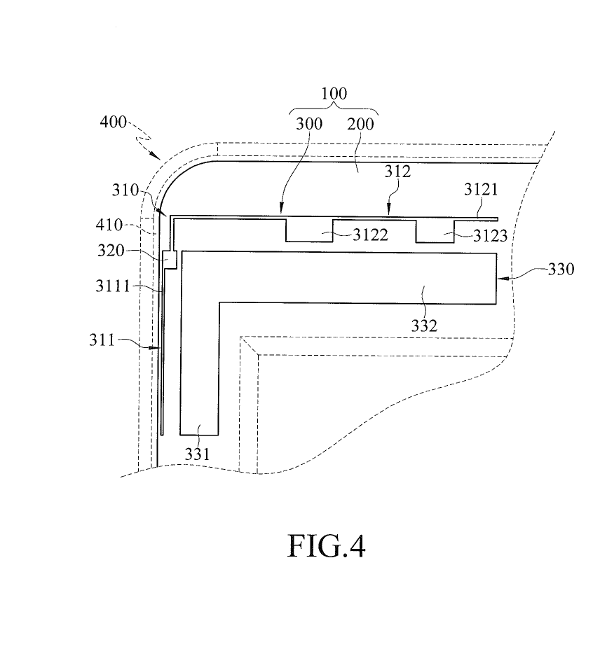

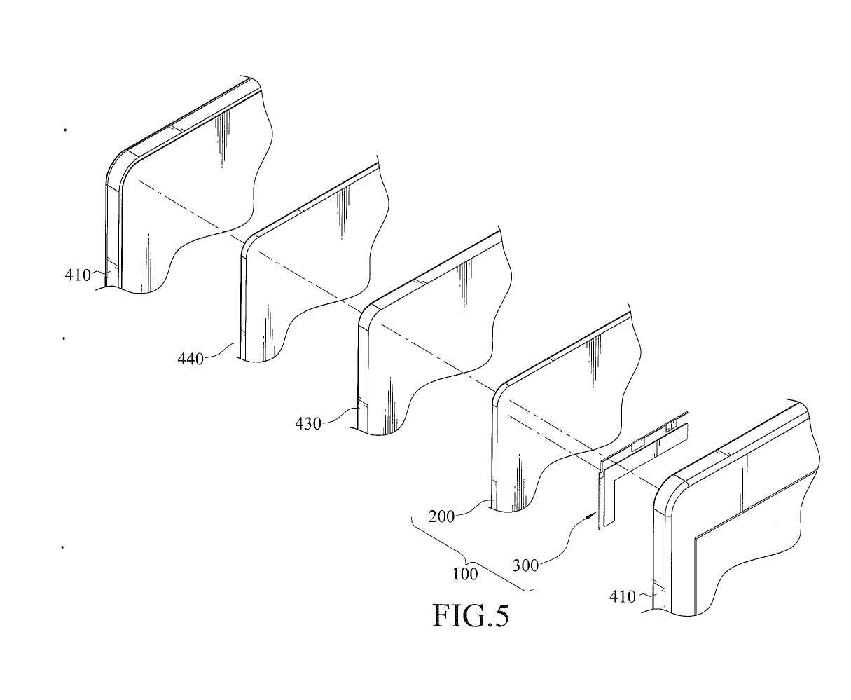

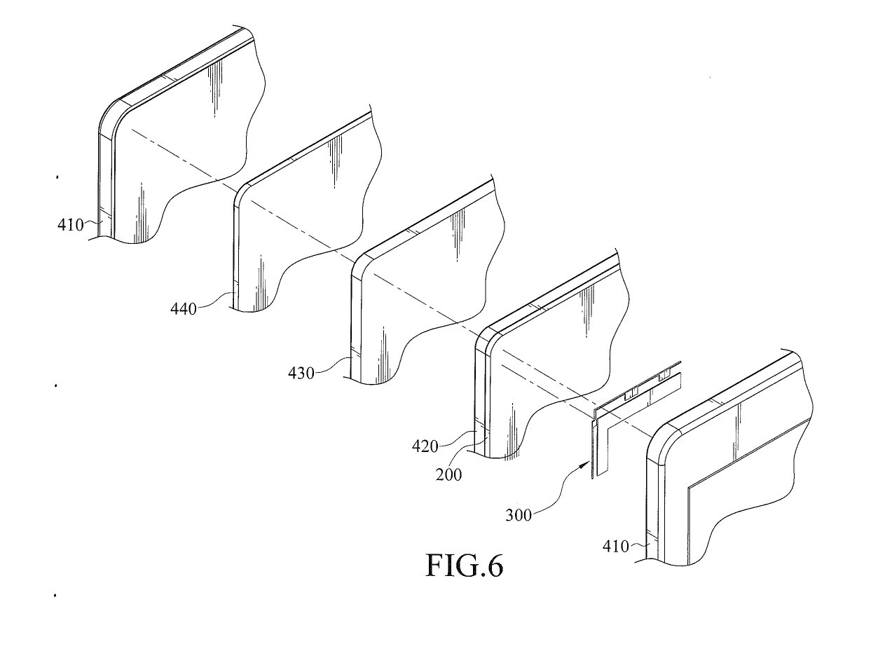

FIG. 4 is a schematic enlarged view of the antenna module 100 in FIG. 3; FIG. 5 is a schematic structural view of the electronic device 400 according to another embodiment of the present invention; and FIG. 6 is a schematic structural view of a touch screen according to another embodiment of the present invention. The antenna module 100, already described in detail in the above embodiment, will not be described herein again.

Referring to FIGS. 3 to 6, the electronic device 400 of this embodiment comprises a mother board 440, a display panel 430, a touch screen 420 and the antenna module 100. The display panel 430, the touch screen 420 and the antenna module 100 may form a touch screen. The touch screen 420 is a common input unit used in an electronic device, for example, in a cell phone or computer. The touch screen 420 generally comprises a touch detection device (not shown) and a touch screen controller (not shown). The touch detection device is installed in front of the display panel, and is used for detecting a touch position of a user and transmitting a touch position sensing signal to the touch screen controller. The touch screen controller receives the signal, converts the signal into a coordinate signal and sends the coordinate signal to a central processor of the electronic device, so that the central processor delivers a command signal after judging and reading the signal to achieve an expected input effect of the user. The touch screen 420 in this embodiment may be, but not limited to, a capacitive touch screen. For example, the touch screen 420 may also be a resistive touch screen, an infrared touch screen or a surface acoustic wave touch screen.

In addition, the transparent substrate 200 of the antenna module 100 may be disposed on the touch screen 420 as an additional component. Or, the transparent substrate 200 is a part of components of the touch screen 420. In other words, the touch screen 420 comprises the transparent substrate 200, and the antenna component 300 of the antenna module 100 is disposed on the transparent substrate 200 of the touch screen 420.

When the touch screen 420 of the touch module is overlapped on and covers the display panel 430 and matches with the display panel 430 to form a touch screen. Moreover, the display panel 430 may be a rigid display, such as a liquid crystal display (LCD), or may be a flexible display, such as an electronic paper (E-paper).

In this embodiment, the display panel 430 is overlapped on and coupled to the mother board 440, and the touch screen 420 is overlapped on and covers the display panel 430. In other words, the touch screen 420 and the mother board 440 are located on two opposite surfaces of the display panel 430. The transparent substrate 200 disposed on the touch screen 420 may be a glass substrate. The antenna component 300 is disposed on the transparent substrate 200. It should be noted that, the mother board 440, the display panel 430, the touch screen 420, the size of the transparent substrate 200, the widths of the first strip portion 331 and the second strip portion 332, and the width from the radiation portion 310 to the grounding portion 330 are presented in a manner that can be clearly understood by a reader. However, the proportions of the components in the drawings are not intended to limit the present invention. Taking a practical case as an example, the widths of the first strip portion 331 and the second strip portion 332 may be smaller than the width of the transparent substrate 200 covered by a frame 410 of the electronic device 400, thus nearly occupying no plane area of the transparent substrate 200. The electronic components of the mother board 440 in the drawings are not the focus of the present invention, and are not shown.

It should be noted that, the electronic device 400 having the touch screen 420 is taken as an example in this embodiment, and is not intended to limit the present invention. For example, in another embodiment of the present invention, the electronic device 400 may not comprise the touch screen 420, and the transparent substrate 200 is directly overlapped on and covers the display panel 430.

Through the above design, the antenna module 100 does not need to be disposed on the mother board 440, and thus the circuit layout space of the mother board 440 is saved, so as to avoid the difficulty of disposing other electronic components on the mother board 440.

In the antenna module 100 of the present invention, the first strip portion 331 and the second strip portion 332 of the grounding portion 330 are combined. An end of the first strip portion 331 is connected to an end of the second strip portion 332, and thus the first strip portion 331 and the second strip portion 332 are in an L-shaped geometric form, so that the shape of the grounding portion 330 is improved to a shape appropriate to be placed at the corner of the transparent substrate 200, and accordingly the antenna component 300 can be directly formed and overlapped on the transparent substrate 200 on the display panel 430.

In the electronic device 400 and the antenna module thereof according to the present invention, the antenna component 300 is directly formed at the corner of the transparent substrate (for example, a glass substrate) of the touch screen 420. The manufacturing process is simple, and the volume of the electronic device 400 is nearly not increased.

Moreover, the antenna module 100 of the present invention is not disposed on the mother board 440, which does not cause difficulty to the disposition of other electronic components on the mother board 440. Compared with the prior art in which the disposition of an antenna line on the mother board 440 causes difficulty in the disposition of other electronic components, the antenna module 100 of the present invention has good structural integrity, thus actually solving the difficulty in the circuit design of the mother board 440 in the prior art. Moreover, since the disposition of the antenna module 100 nearly causes no increase of the volume of the electronic device 400, it facilitates the smaller and thinner development trend of the electronic device 400.

What is claimed is:

1. An electronic device, comprising:
a mother board;
a display panel, overlapped on and coupled to the mother board; and
an antenna module, comprising:
a transparent substrate, overlapped on and covering the display panel, wherein the transparent substrate and the mother board are located on two opposite surfaces of the display panel; and
an antenna component, disposed on the corner of the transparent substrate and not on the mother board and lateral surfaces of the transparent substrate, wherein the antenna component comprises:
at least one radiation portion;
a feed portion; and
a grounding portion, wherein the grounding portion is located at a corner of the transparent substrate, the grounding portion has a first strip portion and a second strip portion, wherein an end of the first strip portion is directly connected to an end of the second strip portion and the end of the first strip portion is approximately perpendicular to the end of the second strip portion, wherein the first strip portion and the second strip portion are respectively located at two edges of the corner of the transparent substrate , wherein the widths of the first strip portion and the second strip portion are smaller than the width of the transparent substrate covered by a frame of the electronic device.

2. The electronic device according to claim 1, wherein the radiation portion further comprises a first radiation portion and a second radiation portion; the first radiation portion has a first axle portion, and the second radiation portion has a second axle portion, a first block and a second block; the first block and the second block are electrically connected to the second axle portion; an end of the first axle portion is electrically connected to an end of the second axle portion; and the first block and the second block act as impedance matching.

3. The electronic device according to claim 1, wherein the radiation portion further comprises a first radiation portion and a second radiation portion; the first radiation portion comprises a first antenna shaft, a second antenna shaft, a first rectangular portion and a second rectangular portion; the first rectangular portion and the second rectangular portion are electrically connected to the second antenna shaft, and an end of the second antenna shaft is electrically connected to an end of the first antenna shaft; the second radiation portion has a third antenna shaft and a third block; the third block is electrically connected to the third antenna shaft; and the first rectangular portion, the second rectangular portion and the third block act as impedance matching.

4. The electronic device according to claim 1, further comprising a touch screen, wherein the touch screen is overlapped on and covering the display panel and placed between the transparent substrate and display panel.

5. The electronic device according to claim 1, wherein the first strip portion and the second strip portion are integrally formed.

6. The electronic device according to claim 1, wherein the first strip portion are covered by a top portion of the frame of the electronic device, and the second strip portion are covered by a side portion of the frame of the electronic device.

7. An electronic device, comprising:
a mother board;
a display panel, overlapped on and coupled to the mother board; and
an antenna module, comprising:
a transparent substrate, overlapped on and covering the display panel, wherein the transparent substrate and the mother board are located on two opposite surfaces of the display panel; and
an antenna component, disposed on the transparent substrate, wherein the antenna component comprises:
a first radiation portion;
a second radiation portion
a feed portion; and
a grounding portion,
wherein the grounding portion has a first strip portion and a second strip portion, wherein an end of the first strip portion is directly connected to an end of the second strip portion and the end of the first strip portion is approximately perpendicular to the end of the second strip portion, wherein an end of the first radiation portion is directly connected to an end of the second radiation portion and the end of the first radiation portion is approximately perpendicular to the end of the second radiation portion, wherein the first radiation portion is substantially parallel to the first strip portion, the second radiation portion is substantially parallel to the second strip portion

8. The electronic device according to claim 7, wherein the antenna component is disposed on the corner of the transparent substrate and not on the mother board and lateral surface of the transparent substrate.

9. The electronic device according to claim 7, wherein the widths of the first strip portion and the second strip portion are smaller than the width of the transparent substrate.

10. The electronic device according to claim 7, wherein the first radiation portion has a first axle portion, and the second radiation portion has a second axle portion, a first block and a second block; the first block and the second block are electrically connected to the second axle portion; an end of the first axle portion is electrically connected to an end of the second axle portion; and the first block and the second block act as impedance matching.

11. The electronic device according to claim 7, wherein the first radiation portion comprises a first antenna shaft, a second antenna shaft, a first rectangular portion and a second rectangular portion; the first rectangular portion and the second rectangular portion are electrically connected to the second antenna shaft, and an end of the second antenna shaft is electrically connected to an end of the first antenna shaft; the second radiation portion has a third antenna shaft and a third block; the third block is electrically connected to the third antenna shaft; and the first rectangular portion, the second rectangular portion and the third block act as impedance matching.

12. The electronic device according to claim 10, wherein the first axle portion is substantially parallel to the first strip portion, the second axle portion is substantially parallel to the second strip portion.

13. The electronic device according to claim 11, wherein the first antenna shaft and the second antenna shaft are substantially parallel to the first strip portion the third antenna shaft is substantially parallel to the second strip portion.
